(19) United States
(12) Patent Application Publication
(10) Pub. No.: US 2019/0243673 A1
(43) Pub. Date: Aug. 8, 2019

(54) SYSTEM AND METHOD FOR TIMING OUT GUEST OPERATING SYSTEM REQUESTS FROM HYPERVISOR LEVEL

(71) Applicant: Nutanix, Inc., San Jose, CA (US)

(72) Inventors: Felipe Franciosi, Cambridge (GB); Miao Cui, New York, NY (US); Malcolm Crossley, Cambridge (GB)

(21) Appl. No.: 15/889,430

(22) Filed: Feb. 6, 2018

(51) Int. Cl. G06F 9/455; G06N 99/00

(52) U.S. Cl. CPC G06F 9/45558; G06F 2009/45591; G06F 2009/45579; G06N 99/005

(57) ABSTRACT

A system and method include generating a transient error at a hypervisor that is responsive to a request sent by a virtual machine that was transmitted to a device. The system and method also include transmitting the transient error from the hypervisor to the virtual machine responsive to a timer for a predetermined period of time expiring before a timeout occurs at the virtual machine. The transient error is transmitted from the hypervisor level to the virtual machine before a timeout occurs at the virtual machine.

### BACKGROUND

The following description is provided to assist the understanding of the reader. None of the information provided or references cited is admitted to be prior art.

Virtual computing systems are widely used in a variety of applications. Virtual computing systems include one or more host machines running one or more virtual machines concurrently. The one or more virtual machines utilize the hardware resources of the underlying one or more host machines. Each virtual machine may be configured to run an instance of an operating system. Modern virtual computing systems allow several operating systems and several software applications to be safely run at the same time on the virtual machines of a single host machine, thereby increasing resource utilization and performance efficiency. Each virtual machine is managed by a hypervisor or virtual machine monitor. The time to complete any given storage operation on computer systems can vary widely depending on the shape of the workload and the type of hardware used. For example, small and sequential read operations can be completed in the order of nanoseconds on modern hardware. In contrast, writing to idle optical media may take up to several seconds for a single operation. Thus, it makes it particularly difficult to define sensible timeouts at the operating system (OS) level and deciding whether an operation has failed or is just taking too long. When operations are deemed to have failed, the result can be catastrophic for the OS. Moreover, the time delays can be increased when using shared storage configurations as the load submitted by each virtual machine can vary drastically. Additionally, each virtual machine has no visibility on the overall status of the storage system or other virtual machines. Finally, under heavy load, operations that normally complete quickly (e.g., in microseconds) could become orders of magnitude slower (e.g., seconds), triggering timeouts and failures on a virtual machine OS. Presented herein is a method for transmitting transient errors from the hypervisor to a virtual machine OS to abort requests from a virtual machine OS before the virtual machine OS triggers its own timeout.

### SUMMARY

In accordance with at least some aspects of the present disclosure, a method is disclosed. The method includes generating a transient error at a hypervisor that is responsive to a request sent by a virtual machine that was transmitted to a device. The method also includes transmitting the transient error from the hypervisor to the virtual machine responsive to a timer for a predetermined period of time expiring before a timeout occurs at the virtual machine.

In accordance with another aspect of the present disclosure, another method is disclosed. The method includes transmitting, by a hypervisor, a request received from a virtual machine to a storage device and starting a transient error timer. The method also includes generating a transient error responsive to the transient error timer expiring without a response from the storage device and transmitting the generated transient error from the hypervisor to the virtual machine.

In accordance with some other aspects of the present disclosure, a system is disclosed. The system includes a virtual machine, a storage device, and a hypervisor. The hypervisor is configured to transmit a request received from the virtual machine to the storage device; start a transient error timer for a predetermined period of time; generate a transient error responsive to the transient error timer expiring without a response from the storage device; and transmit the generated transient error to the virtual machine.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

FIG. 1 is a block diagram of a virtual computing system, in accordance with some embodiments of the present disclosure.

FIG. 2 is a block diagram of a host machine of the virtual computing system of FIG. 1 having a hypervisor with a transient error system, in accordance with some embodiments of the present disclosure.

FIG. 3 is an example process diagram outlining transmissions for generating one or more transient error times for the transient error system of FIG. 2, in accordance with some embodiments of the present disclosure.

FIG. 4 is an example flowchart outlining operations for transmitting transient errors to a virtual machine using the transient error system of FIG. 2, in accordance with some embodiments of the present disclosure.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

The present disclosure is generally directed to a virtual computing system having a plurality of clusters, with each cluster having a plurality of nodes. Each of the plurality of nodes includes one or more virtual machines managed by an instance of a hypervisor. Each virtual machine uses a storage space to store and operate on data. The virtual machine may be managed by a hypervisor, such as an AHV type of hypervisor provided by Nutanix, Inc. When the one or more virtual machines transmit requests to one or more storage devices or other components, the virtual machine waits a predetermined period of time before timing out, which can result in an operating system of the virtual machine crashing. When response times are low and/or network traffic is minimal, the storage device to which the virtual machine communicated can issue a response to the request and/or issue a transient error to the virtual machine. If a transient error is received by the virtual machine, the virtual machine can resubmit the request to the storage device at a later time. However, if response times from the storage device are slow, such as due to multiple queued requests from multiple virtual machines, and/or if network traffic is high, then the storage device may not issue a response or transient error to the virtual machine before the virtual machine times out. When a virtual machine times out, the operating system (OS) may crash or otherwise result in errors.

The present disclosure provides an improved solution. In particular, the present disclosure provides a transient error system for a hypervisor to issue a transient error to the virtual machine. Such a transient error can be issue as a result of a response or transient error from the storage device not being received by the hypervisor within a predetermined period of time for the particular request and/or as a flow control mechanism to control requests. In the instance of a transient error being issued after a predetermined time, the predetermined time can be specific to the type of request and/or storage device to which the request was transmitted. The specific predetermined period of time can be based on a hard-coded response time, a machine learned response time, information transmitted from storage devices or other components for throttling the flow of requests, characteristics of the virtual machine issuing the request, and/or an application or type of application issuing the request.

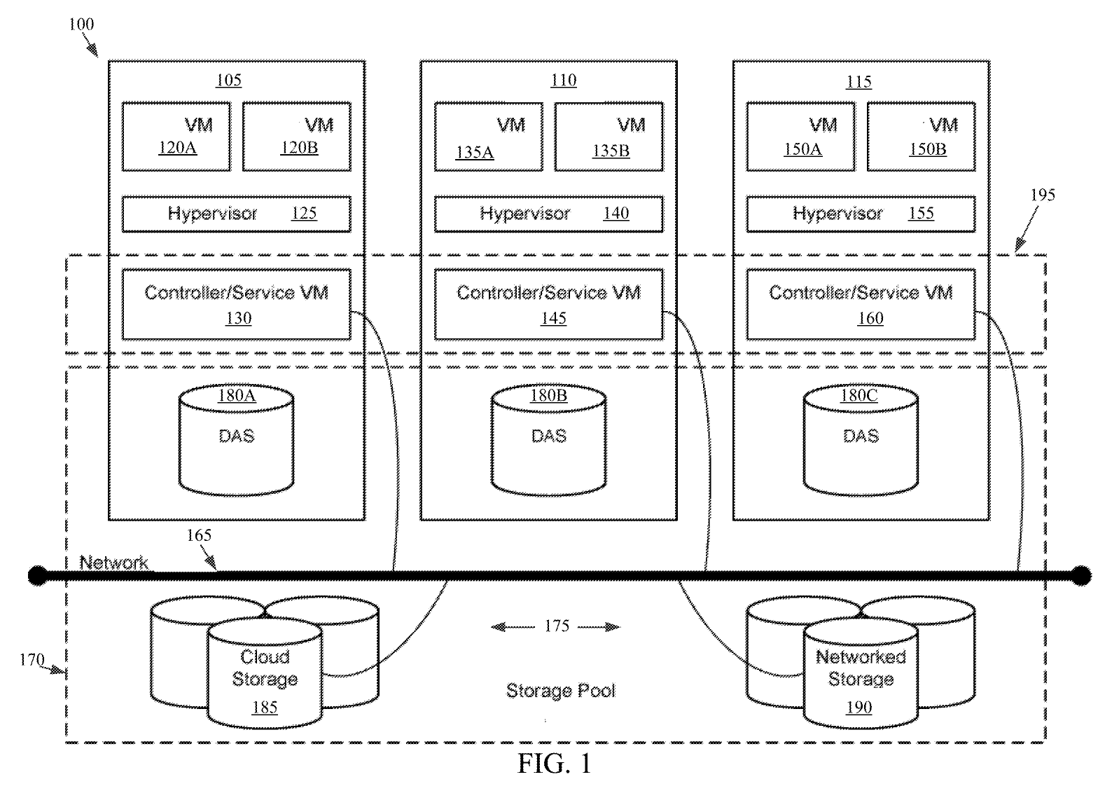

Referring now to FIG. 1, a virtual computing system 100 is shown, in accordance with some embodiments of the present disclosure, though it should be understood that the present disclosure is not limited to a virtual computing system 100 environment. The virtual computing system 100 includes a plurality of nodes, such as a first node 105, a second node 110, and a third node 115. The first node 105 includes user virtual machines (“user VMs”) 120A and 120B (collectively referred to herein as “user VMs 120”), a hypervisor 125 configured to create and run the user VMs, and a controller/service VM 130 configured to manage, route, and otherwise handle workflow requests between the various nodes of the virtual computing system 100. Similarly, the second node 110 includes user VMs 135A and 135B (collectively referred to herein as “user VMs 135”), a hypervisor 140, and a controller/service VM 145, and the third node 115 includes user VMs 150A and 150B (collectively referred to herein as “user VMs 150”), a hypervisor 155, and a controller/service VM 160. The controller/service VM 130, the controller/service VM 145, and the controller/service VM 160 are all connected to a network 165 to facilitate communication between the first node 105, the second node 110, and the third node 115. Although not shown, in some embodiments, the hypervisor 125, the hypervisor 140, and the hypervisor 155 may also be connected to the network 165.

The virtual computing system 100 also includes a storage pool 170. The storage pool 170 may include network-attached storage 175 and direct-attached storage 180A, 180B, and 180C. The network-attached storage 175 may be accessible via the network 165 and, in some embodiments, may include cloud storage 185, as well as local storage area network 190. In contrast to the network-attached storage 175, which is accessible via the network 165, the direct-attached storage 180A, 180B, and 180C may include storage components that are provided within each of the first node 105, the second node 110, and the third node 115, respectively, such that each of the first, second, and third nodes may access its respective direct-attached storage without having to access the network 165.

It is to be understood that only certain components of the virtual computing system 100 are shown in FIG. 1. Nevertheless, several other components that are needed or desired in the virtual computing system to perform the functions described herein are contemplated and considered within the scope of the present disclosure. Additional features of the virtual computing system 100 are described in U.S. Pat. No. 8,601,473, the entirety of which is incorporated by reference herein.

Although three of the plurality of nodes (e.g., the first node 105, the second node 110, and the third node 115) are shown in the virtual computing system 100, in other embodiments, greater than or fewer than three nodes may be used. Likewise, although only two of the user VMs (e.g., the user VMs 120, the user VMs 135, and the user VMs 150) are shown on each of the respective first node 105, the second node 110, and the third node 115, in other embodiments, the number of the user VMs on each of the first, second, and third nodes may vary to include either a single user VM or more than two user VMs. Further, the first node 105, the second node 110, and the third node 115 need not always have the same number of the user VMs (e.g., the user VMs 120, the user VMs 135, and the user VMs 150). Additionally, more than a single instance of the hypervisor (e.g., the hypervisor 125, the hypervisor 140, and the hypervisor 155) and/or the controller/service VM (e.g., the controller/service VM 130, the controller/service VM 145, and the controller/service VM 160) may be provided on the first node 105, the second node 110, and/or the third node 115.

In some embodiments, each of the first node 105, the second node 110, and the third node 115 may be a hardware device, such as a server. For example, in some embodiments, one or more of the first node 105, the second node 110, and the third node 115 may be an NX-1000 server, NX-3000 server, NX-6000 server, NX-8000 server, etc. provided by Nutanix, Inc. or server computers from Dell, Inc., Lenovo Group Ltd. or Lenovo PC International, Cisco Systems, Inc., etc. In other embodiments, one or more of the first node 105, the second node 110, or the third node 115 may be another type of hardware device, such as a personal computer, an input/output or peripheral unit such as a printer, or any type of device that is suitable for use as a node within the virtual computing system 100. In some embodiments, the virtual computing system 100 may be part of a data center.

Each of the first node 105, the second node 110, and the third node 115 may also be configured to communicate and share resources with each other via the network 165. For example, in some embodiments, the first node 105, the second node 110, and the third node 115 may communicate and share resources with each other via the controller/service VM 130, the controller/service VM 145, and the controller/service VM 160, and/or the hypervisor 125, the hypervisor 140, and the hypervisor 155. One or more of the first node 105, the second node 110, and the third node 115 may also be organized in a variety of network topologies, and may be termed as a “host” or “host machine.”

Also, although not shown, one or more of the first node 105, the second node 110, and the third node 115 may include one or more processing units configured to execute instructions. The instructions may be carried out by a special purpose computer, logic circuits, or hardware circuits of the first node 105, the second node 110, and the third node 115. The processing units may be implemented in hardware, firmware, software, or any combination thereof. The term “execution” is, for example, the process of running an application or the carrying out of the operation called for by an instruction. The instructions may be written using one or more programming language, scripting language, assembly language, etc. The processing units, thus, execute an instruction, meaning that they perform the operations called for by that instruction.

The processing units may be operably coupled to the storage pool 170, as well as with other elements of the first node 105, the second node 110, and the third node 115 to receive, send, and process information, and to control the operations of the underlying first, second, or third node. The processing units may retrieve a set of instructions from the storage pool 170, such as, from a permanent memory device like a read only memory (ROM) device and copy the instructions in an executable form to a temporary memory device that is generally some form of random access memory (RAM). The ROM and RAM may both be part of the storage pool 170, or in some embodiments, may be separately provisioned from the storage pool. Further, the processing units may include a single stand-alone processing unit, or a plurality of processing units that use the same or different processing technology.

With respect to the storage pool 170 and particularly with respect to the direct-attached storage 180A, 180B, and 180C, each of the direct-attached storage may include a variety of types of storage devices. For example, in some embodiments, one or more of the direct-attached storage 180A, 180B, and 180C may include, but is not limited to, any type of RAM, ROM, flash memory, magnetic storage devices (e.g., hard disk, floppy disk, magnetic strips, etc.), optical disks (e.g., compact disk (CD), digital versatile disk (DVD), etc.), smart cards, solid state devices, etc. Likewise, the network-attached storage 175 may include any of a variety of network accessible storage (e.g., the cloud storage 185, the local storage area network 190, etc.) that is suitable for use within the virtual computing system 100 and accessible via the network 165. The storage pool 170 including the network-attached storage 175 and the direct-attached storage 180A, 180B, and 180C may together form a distributed storage system configured to be accessed by each of the first node 105, the second node 110, and the third node 115 via the network 165, the controller/service VM 130, the controller/service VM 145, and the controller/service VM 160, and/or the hypervisor 125, the hypervisor 140, and the hypervisor 155. In some embodiments, the various storage components in the storage pool 170 may be configured as virtual disks for access by the user VMs 120, the user VMs 135, and the user VMs 150.

Each of the user VMs 120, the user VMs 135, and the user VMs 150 is a software-based implementation of a computing machine in the virtual computing system 100. The user VMs 120, the user VMs 135, and the user VMs 150 emulate the functionality of a physical computer. Specifically, the hardware resources, such as processing unit, memory, storage, etc., of the underlying computer (e.g., the first node 105, the second node 110, and the third node 115) are virtualized or transformed by the respective hypervisor 125, the hypervisor 140, and the hypervisor 155, respectively, into the underlying support for each of the user VMs 120, the user VMs 135, and the user VMs 150 that may run its own operating system and applications on the underlying physical resources just like a real computer. By encapsulating an entire machine, including CPU, memory, operating system, storage devices, and network devices, the user VMs 120, the user VMs 135, and the user VMs 150 are compatible with most standard operating systems (e.g. Windows, Linux, etc.), applications, and device drivers. Thus, each of the hypervisor 125, the hypervisor 140, and the hypervisor 155 is a virtual machine monitor that allows a single physical server computer (e.g., the first node 105, the second node 110, third node 115) to run multiple instances of the user VMs 120, the user VMs 135, and the user VMs 150, with each user VM sharing the resources of that one physical server computer, potentially across multiple environments. By running the user VMs 120, the user VMs 135, and the user VMs 150 on each of the first node 105, the second node 110, and the third node 115, respectively, multiple workloads and multiple operating systems may be run on a single piece of underlying hardware computer (e.g., the first node, the second node, and the third node) to increase resource utilization and manage workflow.

The user VMs 120, the user VMs 135, and the user VMs 150 are controlled and managed by their respective instance of the controller/service VM 130, the controller/service VM 145, and the controller/service VM 160. The controller/service VM 130, the controller/service VM 145, and the controller/service VM 160 are configured to communicate with each other via the network 165 to form a distributed system 195. Each of the controller/service VM 130, the controller/service VM 145, and the controller/service VM 160 may also include a local management system (e.g., Prism Element from Nutanix, Inc.) configured to manage various tasks and operations within the virtual computing system 100. For example, as discussed below, in some embodiments, the local management system of the controller/service VM 130, the controller/service VM 145, and the controller/service VM 160 may facilitate the transient error system. In other implementations, each VM 120A, 120B, 135A, 135B, 150A, 150B may facilitate the transient error system. In other implementations, each hypervisor 125, 140, 155 may facilitate the transient error system. In still other implementations, an external system may facilitate the transient error system.

The hypervisor 125, the hypervisor 140, and the hypervisor 155 of the first node 105, the second node 110, and the third node 115, respectively, may be configured to run virtualization software, such as, ESXi from VMWare, AHV from Nutanix, Inc., XenServer from Citrix Systems, Inc., etc., for running the user VMs 120, the user VMs 135, and the user VMs 150, respectively, and for managing the interactions between the user VMs and the underlying hardware of the first node 105, the second node 110, and the third node 115. Each of the controller/service VM 130, the controller/service VM 145, the controller/service VM 160, the hypervisor 125, the hypervisor 140, and the hypervisor 155 may be configured as suitable for use within the virtual computing system 100.

The network 165 may include any of a variety of wired or wireless network channels that may be suitable for use within the virtual computing system 100. For example, in some embodiments, the network 165 may include wired connections, such as an Ethernet connection, one or more twisted pair wires, coaxial cables, fiber optic cables, etc. In other embodiments, the network 165 may include wireless connections, such as microwaves, infrared waves, radio waves, spread spectrum technologies, satellites, etc. The network 165 may also be configured to communicate with another device using cellular networks, local area networks, wide area networks, the Internet, etc. In some embodiments, the network 165 may include a combination of wired and wireless communications.

Referring still to FIG. 1, in some embodiments, one of the first node 105, the second node 110, or the third node 115 may be configured as a leader node. The leader node may be configured to monitor and handle requests from other nodes in the virtual computing system 100. The leader node may also be configured to receive and handle requests (e.g., user requests) from outside of the virtual computing system 100. If the leader node fails, another leader node may be designated. Furthermore, one or more of the first node 105, the second node 110, and the third node 115 may be combined together to form a network cluster (also referred to herein as simply “cluster.”) Generally speaking, all of the nodes (e.g., the first node 105, the second node 110, and the third node 115) in the virtual computing system 100 may be divided into one or more clusters. One or more components of the storage pool 170 may be part of the cluster as well. For example, the virtual computing system 100 as shown in FIG. 1 may form one cluster in some embodiments. Multiple clusters may exist within a given virtual computing system (e.g., the virtual computing system 100). The user VMs 120, the user VMs 135, and the user VMs 150 that are part of a cluster can be configured to share resources with each other. In some embodiments, multiple clusters may share resources with one another.

Further, in some embodiments, although not shown, the virtual computing system 100 includes a central management system (e.g., Prism Central from Nutanix, Inc.) that is configured to manage and control the operation of the various clusters in the virtual computing system. In some embodiments, the central management system may be configured to communicate with the local management systems on each of the controller/service VM 130, the controller/service VM 145, the controller/service VM 160 for controlling the various clusters.

Again, it is to be understood again that only certain components of the virtual computing system 100 are shown and described herein. Nevertheless, other components that may be needed or desired to perform the functions described herein are contemplated and considered within the scope of the present disclosure. It is also to be understood that the configuration of the various components of the virtual computing system 100 described above is only an example and is not intended to be limiting in any way. Rather, the configuration of those components may vary to perform the functions described herein.

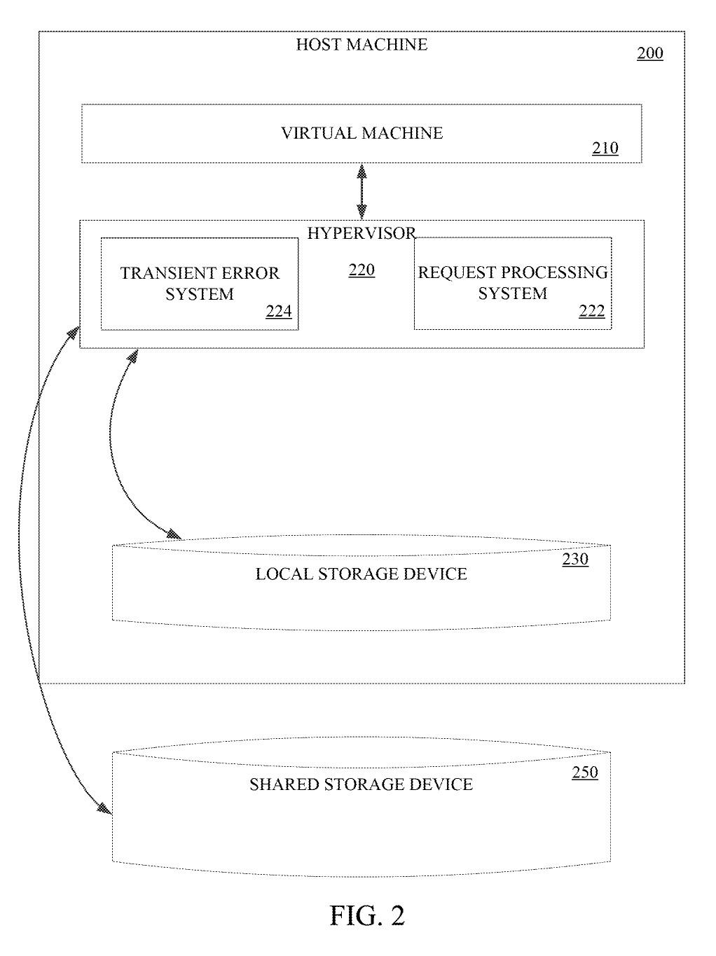

Turning to FIG. 2, a block diagram of a host machine 200 is shown, in accordance with some embodiments of the present disclosure. The host machine 200 can be analogous to the first node 105 discussed with respect to FIG. 1 above. The host machine 200 includes one or more virtual machines 210 operating thereon and a hypervisor 220 configured to create and run the one or more virtual machines 210 executing on the host machine 200. The host machine 200 in the present example includes a local storage device 230 and is also in communication with a shared storage device 250. The local storage device 230 can include, but is not limited to, any type of magnetic storage devices (e.g., hard disk, floppy disk, magnetic strips, etc.), optical disks (e.g., compact disk (CD), digital versatile disk (DVD), etc.), smart cards, solid state devices, etc. Similarly, the shared storage device 250 may include, but is not limited to, any type of magnetic storage devices (e.g., hard disk, floppy disk, magnetic strips, etc.), optical disks (e.g., compact disk (CD), digital versatile disk (DVD), etc.), smart cards, solid state devices, etc. The local storage device 230 and the shared storage device 250 can include arrays of multiple storage devices.

As shown in FIG. 2, the hypervisor 220 creates and runs the virtual machine 210 executing on the host machine 200. When the virtual machine 210 transmits a request, such as an I/O request, the hypervisor 220 is configured to receive the request and route the request, such as through a request processing system 222, to the corresponding component, such as the local storage device 230 and/or shared storage device 250. For communicating over a network to a shared storage device 250, the request processing system 222 of the hypervisor 220 can receive a request from the virtual machine 210, such as a SCSI command, and encapsulate the request for transmission to the shared storage device 250, such as adding a TCP header to form an iSCSI command. The hypervisor 220 of the host machine 200 thus is exposed to each of the requests for the one or more virtual machines 210 executing on the host machine 200. Accordingly, the hypervisor 220 is a central point through which request flow control can be implemented when the number of volume of requests from virtual machines 210 executing on the host machine 200 is too high.

In addition, the hypervisor 220 is the element that receives the responses from the local storage device 230 and/or shared storage device 250 to be transmitted back to the virtual machine 210. For communicating over a network to a shared storage device 250, the request processing system 222 of the hypervisor 220 can receive a response from the shared storage device 250, such as a iSCSI command, and modify the transmission into a format for the virtual machine 210, such as removing a TCP header from an iSCSI command to form a SCSI command to be transmitted to the virtual machine. Thus, in some implementations the devices communicating with the virtual machine 210 through the hypervisor 220 can communicate one or more attributes or conditions of the device to permit the hypervisor 220 to implement flow control as discussed herein.

During normal operation, the requests to and responses from the local storage device 230 and/or shared storage device 250 are within the timeout limits of the virtual machine 210 that transmitted the request. If the local storage device 230 and/or shared storage device 250 cannot process the request in sufficient time, a transient error can be transmitted as a response from the local storage device 230 and/or shared storage device 250 to have the virtual machine 210 resubmit the request. However, if several virtual machines 210 are operating on the host machine 200 and making requests to a local storage device 230 and/or to a shared storage device 250, then the volume of requests can result in delays to the responses and/or delays to the transmission of transient errors due to the queuing of the requests and response and/or due to network conditions for the shared storage device 250. In such situations, one or more virtual machines 210 may reach a timeout condition without a response or a transient error, thereby resulting in an error for the virtual machine 210, which can result in an operating system crash or other faults. Accordingly, the present disclosure includes a transient error system 224 that can be implemented at the hypervisor 220 level to transmit a transient error to one or more virtual machines 210 as a response to their requests even if a response or transient error from the particular local storage device 230 and/or shared storage device 250 has not been received by the hypervisor 220. Such transient errors generated by the transient error system 224 can help prevent timeouts by the one or more virtual machines 210 and/or assist in flow control for reducing the number of requests transmitted to the local storage device 230 and/or shared storage device 250.

In operation, the transient error system 224 can start a timer when a request is received by the hypervisor 220 request processing system 222. The timer maybe for a predetermined period of time, such as a single time for every request (e.g., a fixed millisecond time), a time based on the type of request, a time based on the operating system of the virtual machine 210, a time based on an application executing on the virtual machine 210 that is transmitting the request, and/or combinations thereof. For example, a 4 kilobyte read request should complete in under 10 milliseconds under normal conditions. Thus, the predetermined period of time can be set to 10 milliseconds for such a read request. If the timer expires before the request processing system 222 receives a response or transient error from the local storage device 230 and/or shared storage device 250, then the transient error system 224 generates a transient error based on the request and transmits the transient error to the virtual machine 210 as a response to the request. Thus, the virtual machine 210 can resubmit the request without timing out.

The transient error system 224 can provide an indication to the request processing system 222 to squash or otherwise not forward any response or transient error received from the local storage device 230 and/or shared storage device 250 that is responsive to the original request. Thus, the transient error system 224 provides a man-in-the-middle solution to help reduce the likelihood of a virtual machine 210 timing out when loads on other devices, such as the local storage device 230 and/or shared storage device 250, result in delays to responses and/or when network traffic or conditions increase latency of responses.

In some implementations, the transient error system can modify the predetermined periods of time based on additional factors. For instance, the predetermined periods of time can be modified and/or established via machine learning such that the transient error system 224 is adapted to the particular configuration of the virtual computing system in which the host machine 200 operates. In some implementations, the predetermined periods of time can be modified based on data received from the devices, such as the local storage device 230 and/or shared storage device 250. For instance, the local storage device 230 and/or shared storage device 250 and/or components monitoring the status of such components can transmit data indicative of a slow response time or long queue of requests to the transient error system 224 and/or the hypervisor 220. Responsive to the data indicative of a slow response time or a long queue of requests, the transient error system 224 can shorten the predetermined periods of time before transmitting the transient error and/or can automatically transmit the transient error in response to a request from a virtual machine 210 such that the request load on the particular device, such as the local storage device 230 and/or shared storage device 250, is reduced to allow queued requests and responses to be cleared without adding additional requests to the queue. Thus, the transient error system 224 can be used for flow control of requests at the hypervisor 220 level using generated transient errors even if no response or transient error is received from the device to which the request was sent.

Although not shown, the transient error system 224 and/or the request processing system 222 may be configured as hardware, software, firmware, or a combination thereof. Specifically, the transient error system 224 and/or the request processing system 222 may include one or more processing units configured to execute instructions and one or more memory units to store those instructions and other conversion related data. The instructions may be carried out by a special purpose computer, logic circuits, or hardware circuits of the transient error system 224 and/or the request processing system 222. The processing units may, thus, be implemented in hardware, firmware, software, or any combination thereof. The processing units execute an instruction, meaning that they perform the operations called for by that instruction. The processing units may retrieve a set of instructions from a memory. For example, in some embodiments, the processing units may retrieve the instructions from a permanent memory device like a read only memory (ROM) device and copy the instructions in an executable form to a temporary memory device that is generally some form of random access memory (RAM). The processing units may include a single stand-alone processing unit, or a plurality of processing units that use the same or different processing technology. The instructions may be written using one or more programming language, scripting language, assembly language, etc.

In some implementations, the transient error system 224 and/or the request processing system 222 can be in communication with a user interface. The user interface is used to receive an input from a user, such as one or more of the predetermined periods of time. The user interface may present one or more displays to the user presenting an option (e.g., as a menu item) to designate the one or more periods of time for one or more types of requests, operating systems, and/or applications. The user may interact with the option to set the one or more predetermined periods of time. In further embodiments, the user interface can include diagnostic interfaces, such as a visualization of the volume of transient errors generated, a status or count of the number of transient errors generated, data indicative of one or more values associated with the generated transient errors and/or other outputted information.

It is to be understood that only some components of the hypervisor 220, transient error system 224, and request processing system 222 are shown and described herein. Nevertheless, other components that are considered desirable or needed to perform the functions described herein are contemplated and considered within the scope of the present disclosure.

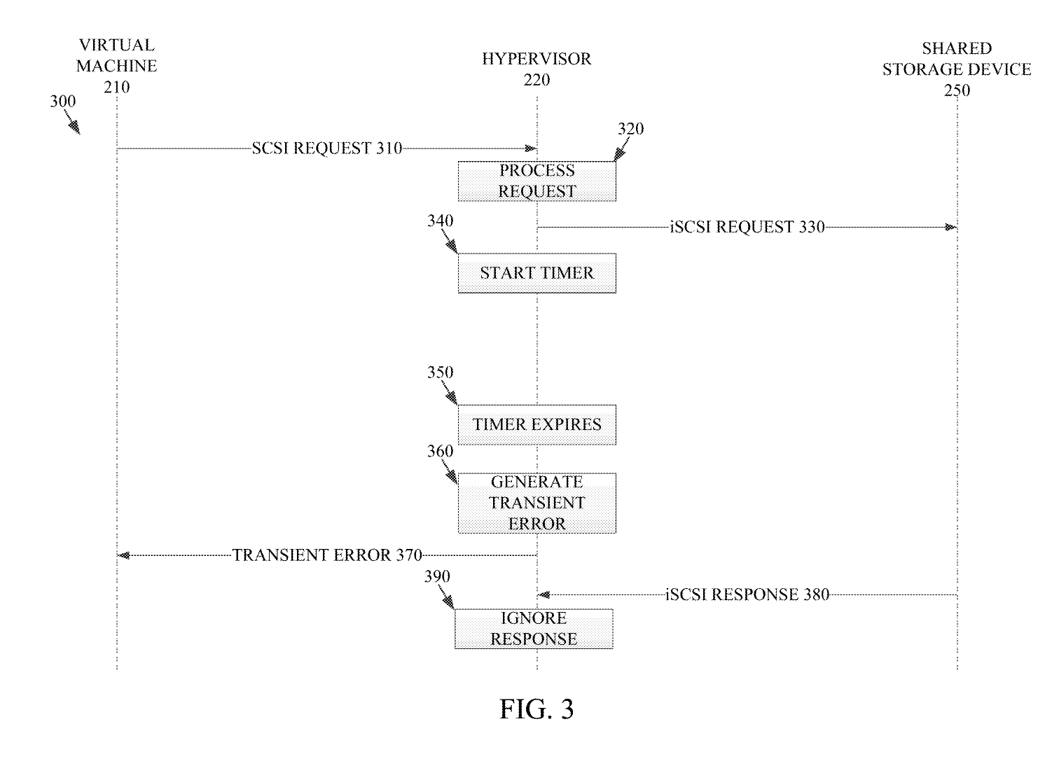

FIG. 3 depicts an example request process 300 that includes the generation of a transient error by the transient error system 224 of FIG. 2. The implementation shown is a SCSI request to a shared storage device 250, though it should be understood that other request types to other devices can implement the same process 300. In the process shown, the virtual machine 210 can transmit a SCSI request 310 to the hypervisor 220. The SCSI request 310 can be processed, such as by the request processing system 222 that can process the request 320 by modifying a format of the request and/or directing the request to the particular device. In the implementation shown, the SCSI request 310 can be modified into an iSCSI request by adding a TCP header and the iSCSI request is transmitted 330 to the shared storage device 250. The transient error system 224 starts a timer 340. In some implementations, the timer can be started when the request is received 310, when the request has been processed 320 and/or when the processed request has been transmitted 330. The length of the timer is based on a predetermined time, such as those discussed above in reference to FIG. 2. If a response or a transient error is received by the hypervisor 220 from the shared storage device 250, then the request processing system 222 can process the iSCSI response by stripping the TCP header from the received response and transmitting the SCSI response or transient error to the virtual machine 210. However, if, as shown in FIG. 3, the timer expires 350 without a response or transient error being received from the shared storage device 250, then the transient error system 224 generates a transient error 360 for the SCSI request 310. The format for particular transient errors is based on the device to which the request was directed. The hypervisor 220 transmits the transient error 370 to the virtual machine 210. Thus, when the virtual machine 210 receives the transient error 370, the virtual machine 210 can reset its timeout conditions and can resubmit the SCSI request 310. If an iSCSI response 380 is received by the hypervisor 220 from the shared storage device 250 during or after the timer expiration 350, then the hypervisor 220 and/or request processing system 222 can ignore the response 390.

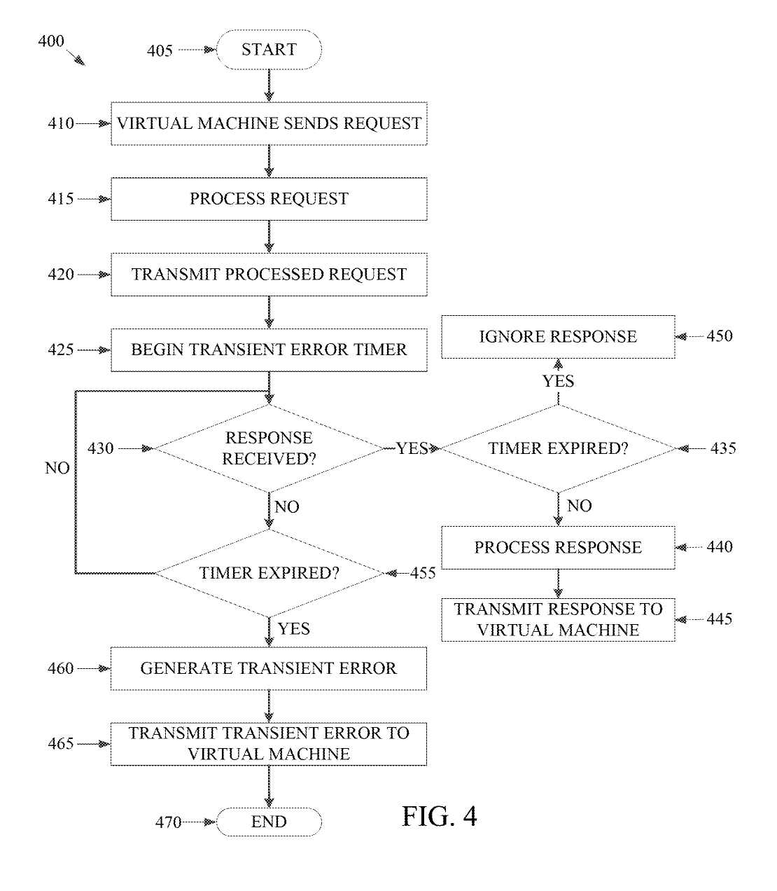

Turning now to FIG. 4, a flowchart outlining a process 400 for transmitting transient errors to a virtual machine using the transient error system, in accordance with some embodiments of the present disclosure. The process 400 may include additional, fewer, or different operations, depending on the particular embodiment. Further, the process 400 is described in conjunction with FIGS. 2-3. Thus, the process 400 is used for transmitting transient errors to a virtual machine 210 using the transient error system 224 from the hypervisor level when the device to which the virtual machine 210 sent a request has not responded within a predetermined period of time.

The process 400 starts at operation 405 with the virtual machine 210 transmitting a request directed to a device 410, such as the local storage device 230 and/or the shared storage device 250. The process 400 includes a request processing system 222 of the hypervisor 220 processing the request 415. In some implementations, processing the request can include routing the request to a particular destination based on the request, such as to the local storage device 230 or the shared storage device 250. In some instances, such as that shown and described in reference to FIG. 3, the processing of the request 415 can include modifying the request to a different format or otherwise modifying the request to be sent to a particular device, such as adding a TCP header for converting a SCSI request to an iSCSI request.

The process 400 further includes transmitting the process request 420. The transmission of the process request can be performed by the hypervisor 220, the request processing system 222, and/or another component of the hypervisor 220 or in communication with the hypervisor 220. The process 400 also includes beginning a transient error timer 425 for the transmitted request. The transient error timer can be started when the request is processed, when the request is received from the virtual machine, or when the processed request is transmitted. The timer is based on a predetermined period of time. The predetermined period of time can be a fixed time, a period of time based on the type of request, a period of time based on an operating system of the virtual machine, a period of time based on the application transmitting the request, a period of time based on the device to which the request is being sent, a period of time based on data received from the device to which the request is being sent and/or another device monitoring the device to which the request is being sent, or combinations thereof. The period of time based on the type of request, operating system, application, and/or device to which the request was sent can be empirically determined, such as via testing average response times on a particular set up and/or based on machine learning. The period of time based on the data received from the device to which the request is being sent and/or another device monitoring the device to which the request is being sent can be received by the hypervisor 220 to be used to set a predetermined period of time and/or to adjust any of the other periods of time (e.g., fixed, based on request type, etc.).

The process 400 further includes determining if a response from the device has been received 430. If a respond from the device to which the request was transmitted has been received, the process 400 determines if the transient error timer has expired 435. If the transient error timer has expired, then the response is ignored 450. If the transient error timer has not expired, then the response is processed 440. The processing can include modifying the received response to a different format or otherwise modifying the response, such as stripping a TCP header for converting an iSCSI response to a SCSI response to be sent to the virtual machine 210. The processed response is then transmitted to the virtual machine 445.

If no response has been received, then the process 400 determines if the transient error timer has expired 455. If the timer has not expired, then the process 400 returns to determining if a response has been received 430. In some instances, a dwell or pause time can be implemented upon returning to operation 430. If the transient error timer has expired, then a transient error is generated 460 by the transient error system 224 and is transmitted to the virtual machine 465. The process then ends 470.

Thus, the present disclosure provides a system and method for transmitting transient errors to a virtual machine when a device does not send a response or transient error responsive to the request within a predetermined period of time. Such a generated transient error at the hypervisor level can prevent a timeout from occurring at the virtual machine, which may cause an operating system of the virtual machine to crash or otherwise result in other faults.

Although the present disclosure has been described with respect to software applications, in other embodiments, one or more aspects of the present disclosure may be applicable to other components of the virtual computing system 100 that may be suitable for real-time monitoring by the user.

It is also to be understood that in some embodiments, any of the operations described herein may be implemented at least in part as computer-readable instructions stored on a computer-readable memory. Upon execution of the computer-readable instructions by a processor, the computer-readable instructions may cause a node to perform the operations.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1. A method comprising:
generating a transient error at a hypervisor that is responsive to a request sent by a virtual machine that was transmitted to a device; and
transmitting the transient error from the hypervisor to the virtual machine responsive to a timer for a predetermined period of time expiring before a timeout occurs at the virtual machine.

2. The method of claim 1, wherein the predetermined period of time is a fixed time.

3. The method of claim 1, wherein the predetermined period of time is based on a type of request sent by the virtual machine.

4. The method of claim 1 wherein the predetermined period of time is based on an operating system of the virtual machine.

5. The method of claim 1 wherein the predetermined period of time is based on an application sending the request from the virtual machine.

6. The method of claim 1, wherein the predetermined period of time is based on machine learning.

7. The method of claim 1, wherein the predetermined period of time is based on data received from a device to which the request was transmitted.

8. The method of claim 1, further comprising starting the timer for the predetermined period of time responsive to the hypervisor receiving the request from the virtual machine.

9. The method of claim 1, further comprising starting the timer for the predetermined period of time responsive to the hypervisor transmitting the request to the device.

10. The method of claim 1, further comprising starting the timer for the predetermined period of time responsive to the hypervisor processing the request from the virtual machine.

11. The method of claim 1, wherein the device is a storage device.

12. A method comprising:
transmitting, by a hypervisor, a request received from a virtual machine to a storage device;
starting a transient error timer;
generating a transient error responsive to the transient error timer expiring without a response from the storage device; and
transmitting the generated transient error from the hypervisor to the virtual machine.

13. The method of claim 12 further comprising:
processing, by the hypervisor, the request received from the virtual machine.

14. The method of claim 12 further comprising:
receiving a response from the storage device after the timer has expired; and
ignoring the response.

15. The method of claim 12, wherein the transient error timer is for a predetermined period of time based on the type of the request.

16. A system comprising:
a virtual machine;
a storage device; and
a hypervisor configured to:
transmit a request received from the virtual machine to the storage device,
start a transient error timer for a predetermined period of time,
generate a transient error responsive to the transient error timer expiring without a response from the storage device, and
transmit the generated transient error to the virtual machine.

17. The system of claim 16, wherein the predetermined period of time is a fixed time.

18. The system of claim 16, wherein the predetermined period of time is based on a type of request sent by the virtual machine.

19. The system of claim 16, wherein the predetermined period of time is based on an operating system of the virtual machine.

20. The system of claim 16, wherein the predetermined period of time is based on an application sending the request from the virtual machine.

21. A non-transitory computer readable memory storing computer program code to cause a computer to perform a method comprising:
generating a transient error at a hypervisor that is responsive to a request sent by a virtual machine that was transmitted to a device; and
transmitting the transient error from the hypervisor to the virtual machine responsive to a timer for a predetermined period of time expiring before a timeout occurs at the virtual machine.

22. The non-transitory computer readable memory of claim 21, wherein the predetermined period of time is based on a type of request sent by the virtual machine.

23. The non-transitory computer readable memory of claim 21, wherein the predetermined period of time is based on an operating system of the virtual machine.

24. The non-transitory computer readable memory of claim 21, further comprising starting the timer for the predetermined period of time responsive to the hypervisor receiving the request from the virtual machine.

25. The non-transitory computer readable memory of claim 21, further comprising starting the timer for the predetermined period of time responsive to the hypervisor transmitting the request to the device.

26. The non-transitory computer readable memory of claim 21, further comprising starting the timer for the predetermined period of time responsive to the hypervisor processing the request from the virtual machine.
